(19) United States
(12) Patent Application Publication
(10) Pub. No.: US 2013/0145273 A1
(43) Pub. Date: Jun. 6, 2013

(54) METHODS AND DEVICES FOR CONFIGURING A WEB BROWSER BASED ON AN OTHER PARTY'S PROFILE

(71) Applicants: James Allen Hymel, Kitchener (CA); William Donald Santo, Waterloo (CA); Alec Reid Thomas, Toronto (CA); Janine Mary Hodder, Waterloo (CA)

(72) Inventors: James Allen Hymel, Kitchener (CA); William Donald Santo, Waterloo (CA); Alec Reid Thomas, Toronto (CA); Janine Mary Hodder, Waterloo (CA)

(73) Assignee: RESEARCH IN MOTION LIMITED, Waterloo, ON (CA)

(21) Appl. No.: 13/583,061

(22) PCT Filed: Dec. 2, 2011
(86) PCT No.: PCT/CA2011/050745

§ 371 Date: Sep. 6, 2012

(51) Int. Cl. G06F 3/0484

(52) U.S. Cl. CPC G06F 3/0484
USPC 715/733

(57) ABSTRACT

Methods and devices for configuring a web browser based on an other party's profile are described. In one aspect, the method includes: receiving a selection of an other party's identifier within a web browser; and in response to receiving the selection of the other party's identifier: i) receiving an other party's profile associated with the other party's identifier; and ii) configuring the web browser based on the other party's profile. In another aspect, the present application describes a method implemented by a web server. The web server has stored therein an other party's profile. The method includes: receiving a selection of an other party's identifier; and in response to receiving a selection of the other party's identifier: i) retrieving an other party's profile associated with the other party's identifier; and ii) sending the other party's profile to the electronic device.

### TECHNICAL FIELD

The present application relates to methods and systems for managing and configuring a web browser, and more particularly to methods and electronic devices for configuring a web browser based on an other party's profile.

### BACKGROUND

The Internet provides a media outlet for various companies, groups and individuals to provide information on an other party's endorsed cultural trends.

Such other parties may, for example, be celebrities. Celebrities are often admired and followed for popular cultural advice regarding fashion, food, hobbies, etc. As such, products and activities that are endorsed by celebrities may define emerging cultural trends. Individuals interested in celebrity defined cultural trends often follow various media outlets such as the Internet, magazines, newspapers and television programs in order to keep up to date with the latest cultural trends.

By way of example, certain webpages and web based applications allow an Internet user to view products and activities endorsed by an other party (such as an admired celebrity) as well as the other party's general view on these products and activities. However, these webpages and web based applications are limited in scope to simply providing an other party's recommendations of products and activities to an Internet user. That is, such webpages may require extensive web navigation in order to locate and display an other party's recommendations.

### BRIEF DESCRIPTION OF THE DRAWINGS

Reference will now be made, by way of example, to the accompanying drawings which show example embodiments of the present disclosure, and in which:

FIG. 1 is a block diagram illustrating an example operating environment in accordance with example embodiments of the present disclosure;

FIG. 2 is a block diagram illustrating an example web server in accordance with example embodiments of the present disclosure;

FIG. 3 is a block diagram illustrating an example electronic device in accordance with example embodiments of the present disclosure;

FIG. 4 is a flowchart illustrating an example method of using an other party's profile to configure a web browser in accordance with example embodiments of the present disclosure;

FIG. 5 is a flowchart illustrating an example method of using a bookmark in an other party's profile to configure a web browser in accordance with example embodiments of the present disclosure;

FIG. 6 is a flowchart illustrating an example method of using a cookie in an other party's profile to configure a web browser in accordance with example embodiments of the present disclosure; and

FIG. 7 is a flowchart illustrating an example method of using a web browsing history in an other party's profile to configure a web browser in accordance with example embodiments of the present disclosure.

Like reference numerals are used in the drawings to denote like elements and features.

### DETAILED DESCRIPTION

In one aspect, the present application describes a method implemented by a processor of an electronic device. The method includes: receiving a selection of an other party's identifier within a web browser; and in response to receiving the selection of the other party's identifier: i) receiving an other party's profile associated with the other party's identifier; and ii) configuring the web browser based on the other party's profile.

In another aspect, the present application describes an electronic device. The electronic device includes a memory and a processor coupled with the memory. The processor is configured for: receiving a selection of an other party's identifier within a web browser; and in response to receiving the selection of the other party's identifier: i) receiving an other party's profile associated with the other party's identifier; and ii) configuring the web browser based on the other party's profile.

In yet another aspect, the present application describes a method implemented by a web server. The web server has stored therein an other party's profile. The method includes: receiving a selection of an other party's identifier; and in response to receiving a selection of the other party's identifier: i) retrieving an other party's profile associated with the other party's identifier; and ii) sending the other party's profile to the electronic device.

In yet a further aspect, the present application describes a web server. The web server includes a memory having stored therein an other party's profile and a processor coupled with the memory. The processor is configured for: receiving a selection of an other party's identifier; and in response to receiving a selection of the other party's identifier: i) retrieving an other party's profile associated with the other party's identifier; and ii) sending the other party's profile to the electronic device.

Other example embodiments of the present disclosure will be apparent to those of ordinary skill in the art from a review of the following detailed description in conjunction with the drawings.

Example embodiments of the present disclosure are not limited to any particular operating system, mobile device architecture, server architecture or computer programming language.

### System Overview

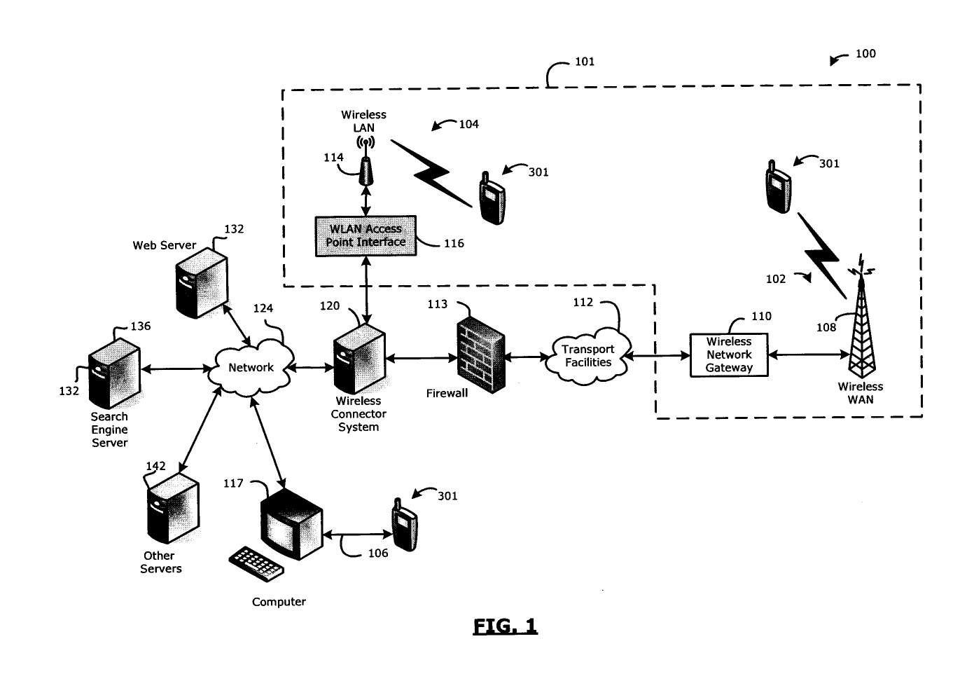

Reference is first made to FIG. 1, which shows in block diagram form a communication system 100 in which example embodiments of the present disclosure can be applied. The communication system 100 includes a number of electronic devices 301 which may be connected to the remainder of the system 100 in any of several different ways. In the example embodiment illustrated, the electronic devices 301 are mobile communication devices. That is, the electronic devices 301 are configured to communicate with other electronic devices, servers and/or systems (i.e. they are “communication” devices) and the electronic devices 301 are portable and may be easily moved between different physical locations (i.e. they are “mobile” devices). However, in other example embodiments, the electronic devices 301 may not be portable (i.e. may not be “mobile” devices).

Accordingly, several instances of electronic devices 301 are depicted in FIG. 1 employing different example ways of connecting to the system 100. The electronic devices 301 are connected to a communication network such as a wireless network 101 which may include one or more of a Wireless Wide Area Network (WWAN) 102 and a Wireless Local Area Network (WLAN) 104 or other suitable network arrangements. In some example embodiments, the electronic devices 301 are configured to communicate over both the WWAN 102 and WLAN 104, and to roam between these networks. In some example embodiments, the wireless network 101 may include multiple WWANs 102 and WLANs 104.

The WWAN 102 may be implemented as any suitable wireless access network technology. By way of example but not limitation, the WWAN 102 may be implemented as a wireless network that includes a number of transceiver base stations 108 (one of which is shown in FIG. 1) where each of the base stations 108 provides wireless Radio Frequency (RF) coverage to a corresponding area or cell. The WWAN 102 may be operated by a mobile network service provider that provides subscription packages to users of the electronic devices 301. In some example embodiments, the WWAN 102 conforms to one or more of the following wireless network types: Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network), EvDO (Evolution-Data Optimized) CDMA2000, EDGE (Enhanced Data rates for GSM Evolution), UMTS (Universal Mobile Telecommunication Systems), HSDPA (High-Speed Downlink Packet Access), IEEE 802.16e (also referred to as Worldwide Interoperability for Microwave Access or “WiMAX), or various other networks. Although WWAN 102 is described as a “Wide-Area” network, that term is intended herein also to incorporate wireless Metropolitan Area Networks (WMAN) and other similar technologies for providing coordinated service wirelessly over an area larger than that covered by typical WLANs.

The WWAN 102 may further include a wireless network gateway 110 which connects the electronic devices 301 to transport facilities 112, and through the transport facilities 112 to a wireless connector system 120. Transport facilities 112 may include one or more private networks or lines, the public Internet, a virtual private network, or any other suitable network. The wireless connector system 120 may be operated, for example, by an organisation or enterprise such as a corporation, university, or governmental department, which allows access to a network 124 such as an internal or enterprise network and its resources, or the wireless connector system 120 may be operated by a mobile network provider. In some example embodiments, the network 124 may be realised using the Internet rather than an internal or enterprise network.

The wireless network gateway 110 provides an interface between the wireless connector system 120 and the WWAN 102, which facilitates communication between the electronic devices 301 and other devices (not shown) connected, directly or indirectly, to the WWAN 102. Accordingly, communications sent via the electronic devices 301 are transported via the WWAN 102 and the wireless network gateway 110 through transport facilities 112 to the wireless connector system 120. Communications sent from the wireless connector system 120 are received by the wireless network gateway 110 and transported via the WWAN 102 to the electronic devices 301.

The WLAN 104 includes a wireless network which, in some example embodiments, conforms to IEEE 802.11x standards (sometimes referred to as Wi-Fi) such as, for example, the IEEE 802.11a, 802.11b and/or 802.11g standard. Other communication protocols may be used for the WLAN 104 in other example embodiments such as, for example, IEEE 802.11n, IEEE 802.16e (also referred to as Worldwide Interoperability for Microwave Access or “WiMAX”), or IEEE 802.20 (also referred to as Mobile Wireless Broadband Access). The WLAN 104 includes one or more wireless RF Access Points (AP) 114 (one of which is shown in FIG. 1) that collectively provide a WLAN coverage area.

The WLAN 104 may be a personal network of the user, an enterprise network, or a hotspot offered by an Internet service provider (ISP), a mobile network provider, or a property owner in a public or semi-public area, for example. The access points 114 are connected to an access point (AP) interface 116 which may connect to the wireless connector system 120 directly (for example, if the access point 114 is part of an enterprise WLAN 104 in which the wireless connector system 120 resides), or indirectly via the transport facilities 112 if the access point 114 is a personal Wi-Fi network or Wi-Fi hotspot (in which case a mechanism for securely connecting to the wireless connector system 120, such as a virtual private network (VPN), may be required). The AP interface 116 provides translation and routing services between the access points 114 and the wireless connector system 120 to facilitate communication, directly or indirectly, with the wireless connector system 120.

The wireless connector system 120 may be implemented as one or more servers, and is typically located behind a firewall 113. The wireless connector system 120 manages communications, including email messages, to and from a set of managed electronic devices 301. The wireless connector system 120 also provides administrative control and management capabilities over users and electronic devices 301 which may connect to the wireless connector system 120.

The wireless connector system 120 allows the electronic devices 301 to access the network 124 and connected resources and services such as a web server 132 (for providing Internet content to the electronic devices 301 in the wireless network 101), a search engine server 136 (which may be a web server 132 which is capable of searching the Internet and/or other web servers 132 for content) and/or other servers 142. The other servers 142 may include a messaging server (for example, a Microsoft Exchange™, IBM Lotus Domino™, or Novell GroupWise™ email messaging server) and an application server for implementing server-based applications such as instant messaging (IM) applications.

The wireless connector system 120 typically provides a secure exchange of data (e.g. email messages, contact data, personal information manager (PIM) data, and IM data) with the electronic devices 301. In some example embodiments, communications between the wireless connector system 120 and the electronic devices 301 are encrypted. In some example embodiments, communications are encrypted using a symmetric encryption key implemented using Advanced Encryption Standard (AES) or Triple Data Encryption Standard (Triple DES) encryption. Private encryption keys are generated in a secure, two-way authenticated environment and are used for both encryption and decryption of data.

The wireless network gateway 110 is adapted to send data packets received from the electronic devices 301 over the WWAN 102 to the wireless connector system 120. The wireless connector system 120 then sends the data packets to the appropriate connection point, such as the web server 132, search engine server 136 or other servers 142. Conversely, the wireless connector system 120 sends data packets received, for example, from the web server 132, search engine server 136 or other servers 142 to the wireless network gateway 110 which then transmit the data packets to the destination electronic devices 301. The AP interfaces 116 of the WLAN 104 provide similar sending functions between the electronic devices 301, the wireless connector system 120 and network connection point such as the web server 132, search engine server 136 or other servers 142.

The network 124 may include a private local area network, metropolitan area network, wide area network, the public Internet or combinations thereof and may include virtual networks constructed using any of these, alone, or in combination.

An electronic device 301 may alternatively connect to the wireless connector system 120 using a computer 117, such as a desktop or a notebook computer, via the network 124. A link 106 may be provided for exchanging information between the electronic device 301 and computer 117 connected to the wireless connector system 120. The link 106 may include one or both of a physical interface and short-range wireless communication interface. The physical interface may include one or combinations of an Ethernet connection, Universal Serial Bus (USB) connection, Firewire™ (also known as an IEEE 1394 interface) connection, or other serial data connection, via respective ports or interfaces of the mobile electronic device 301 and computer 117. The short-range wireless communication interface may be a personal area network (PAN) interface. A personal area network is a wireless point-to-point connection meaning no physical cables are required to connect the two end points. The short-range wireless communication interface may include one or a combination of an infrared (IR) connection such as an Infrared Data Association (IrDA) connection, a short-range radio frequency (RF) connection such as one specified by IEEE 802.15.1 or the Bluetooth™ special interest group, or IEEE 802.15.3a, also referred to as UltraWideband (UWB), or other PAN connection.

It will be appreciated that the above-described communication system 100 is provided for the purpose of illustration only, and that the above-described communication system 100 includes one possible communication network configuration of a multitude of possible configurations for use with the electronic devices 301. The teachings of the present application may be employed in connection with any other type of network and associated devices that are effective in implementing or facilitating wireless communication. Suitable variations of the communication system are intended to fall within the scope of the present application.

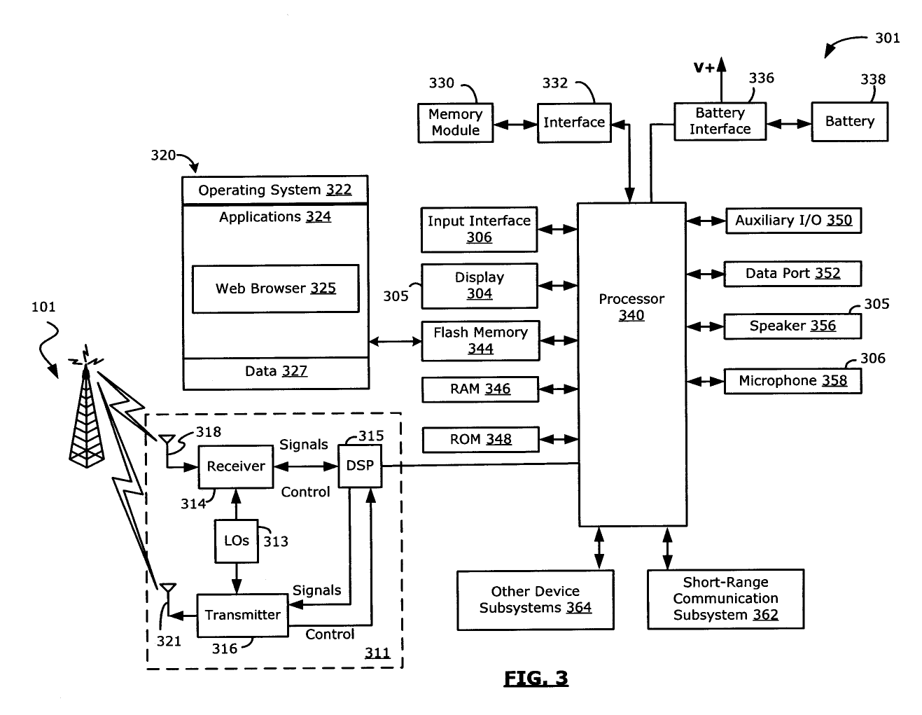

Accordingly, an electronic device 301 may have Internet access. That is, in at least some example embodiments, the electronic device 201 may be configured to connect to the Internet through a communication system, such as the communication system 100 of FIG. 1. In at least some example embodiments, the communication system 100 may allow the electronic device 301 to access one or more web servers 132 which are publicly or privately accessible through the Internet. Web servers 132 are servers which are configured to deliver content, such as webpages on request from electronic devices 301 connected to the Internet. In at least some example embodiments, a web server 132 may be configured to deliver HyperText Markup Language (HTML) documents to electronic devices 301. In at least some example embodiments, one or more of the web servers may be configured to deliver content to an electronic device 301 in response to receiving a Hypertext Transfer (or Transport) Protocol (HTTP) request from a web browser 325 (FIG. 3) operating on that electronic device 301.

A web server 132 may have one or more addresses associated with that web server 132. An address may, for example, be in the form of a Uniform Resource Locator (URL). The web server may be configured to map a path component of an address, such as a URL, to a local file system if the request received from an electronic device 301 is a static request or to a program name if the request received from the electronic device 301 is a dynamic request.

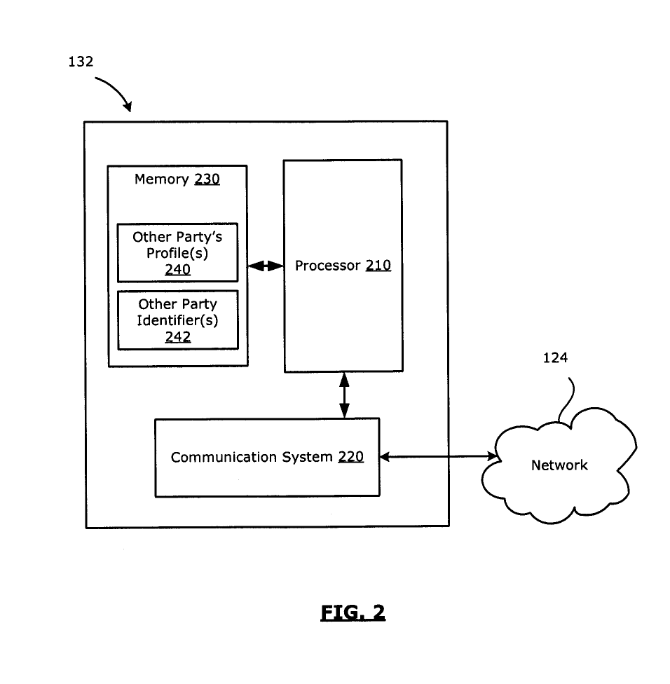

Example components and features of the web server 132 will be discussed in greater detail below with reference to FIG. 2.

In at least some example embodiments, the communication system 100 may allow the electronic device 301 to access one or more search engine servers 136 through the Internet. Search engine servers 136 are web servers 132 configured to search the Internet and/or other web servers 132 for content and to provide search results to electronic devices 301. In at least some example embodiments, a search engine server 136 stores information about webpages that may be retrieved. These webpages may be retrieved by a web crawler, which is an application that browses the Internet and/or web servers 132 for webpages. The web crawler may also identify URL links within a webpage and retrieve other webpages associated with those URL links. The retrieved webpages are then indexed based on the content of the webpages, and the indexed webpages may be stored in a database within the search engine server 136 for use in a later query request from electronic devices 301 connected to the search engine server 136 (e.g. via the Internet). In response to a query request received from an electronic device 201, the search engine server 136 examines the indexed webpages and provides a list of best-matching webpages. In at least some example embodiments, the list may include the webpage titles and some content of the webpages. Example search engine servers 136 may include Google Search™, Yahoo Search™ and MSN Search™.

### Example Web Server

Reference is next made to FIG. 2 which illustrates an example web server 132. The web server 132 may include a housing (not shown) which houses the components of the web server 132. The web server 132 includes a processor 210 (such as a microprocessor) which controls the overall operation of the web server 132. The processor 210 interacts with a communication system 220 to perform communication functions via the network 124 with other systems, servers and/or devices such as the electronic devices 301 (FIG. 1). The processor 210 interacts with additional components including a memory 230.

The processor 210 may store data in the memory 230 such as, for example, webpages which may, in at least some example embodiments, be embodied as HTML documents.

In at least some example embodiments, the web server 132 may be configured to provide a browsing experience of an other party in a web browser 325 (FIG. 3) associated with an electronic device 301. That is, in at least some example embodiments, the web server 132 is configured to allow users associated with an electronic device 301 to experience the web based, at least in part, on one or more characteristics, interests, preferences, historical information, and/or configurations associated with an other party. In example embodiments, the other person is a person (e.g. celebrity, chef, athlete, actor, musician, motivational speaker, financial advisor, tour guide, friend, acquaintance, relative, teacher, business contact, business leader, political leader, religious leader). In other example embodiments, the other party is an organization (e.g. athletic organization, musical organization, social group, family, educational organization, business organization, political organization, religious organization). In at least some example embodiments, the web server 132 may allow users associated with electronic devices 301 to experience the web as though they were the other party (if the other party is a person) or as though they were a member of the other party (if the other party is an organization). The web server 132 may allow a web browser 325 (FIG. 3) operating on an electronic device 301 to inherit one or more properties associated with the other party (such as one or more characteristics, interests, preferences, historical information, and/or configurations associated with an other party). In at least some embodiments, the other party may be referred to as a third party. That is, in at least some embodiments, references to the “other party” may be replaced with “third party.”

In at least some example embodiments, in order to provide an other party's browsing experience to an electronic device 301, the web server 132 may have access to one or more other party's profile 240. In at least some example embodiments, the other party's profile 240 may be stored in memory 230 of the web server 132. The other party's profile 240 may define characteristics, interests, preferences, historical information, and/or configurations associated with the other party. Each other party's profile 240 may be associated with a specific other party.

The other party's profile 240 may include a cookie, a bookmark, a web browser history, and/or a geographic location associated with the other party. In at least some example embodiments, the other party's profile is a profile defined for a party who is not a user of the electronic device 301. That is, the other party's profile which will be provided to an electronic device 301 was defined for someone other than the user of that electronic device 301.

The web server 132 may also store one or more other party's identifier 242. An other party's identifier 242 may be associated with the other party's profile 240 and with the other party. The other party's identifier 232 may identify the other party associated with the other party's profile 240. For example, the other party's identifier 232 may include one or more name (such as a first name, middle name, and/or last name) of the other party. The other party's identifier 242 includes information which may be displayed to a user of an electronic device 301 (i.e. a person who is not the other party) to allow the user to identify the other party associated with the other party's profile 240.

The other party's identifier 242 and the other party's profile 240 may be stored in a manner which maintains an association between the other party's identifier 242 and the other party's profile 240 which are both associated with the same other party. That is, the other party's profile 240 and other party's identifier 242 may be stored so that the web server 132 is able to select an other party's profile 240 which is associated with a specific other party's identifier 242. Other party profiles 240 and corresponding other party identifiers are effectively linked together by the web server 132.

In at least some example embodiments, the other party's identifier 242 may be stored within the other party's profile 240. That is, a portion of the other party's profile 240 may include identifying information (such as one or more names) associated with the other party.

In at least some example embodiments, one or more other party's identifier 242 may be stored in one or more webpages. In at least some such example embodiments, the one or more webpages may list information (such as a name) which identifies an other party. The other party's identifier 242 may be provided by way of a link which connects to the other party's profile 240 associated with the same other party. That is, the link may point to the other party's profile 240 which is associated with the other party's identifier 242. The link may, in at least some example embodiments, be a Uniform Resource Locator (URL).

While the memory 230 is illustrated as a single component, it will typically include multiple memory components of various types. For example, the memory 230 may include Random Access Memory (RAM), Read Only Memory (ROM), a Hard Disk Drive (HDD), a Solid State Drive (SSD), Flash Memory, or other types of memory. It will be appreciated that each of the various memory types will be best suited for different purposes and applications.

The processor 210 may operate under stored program control and execute software modules (not shown) which may be stored in the memory 230. The software modules may include operating system software and other software applications to carry out specific functions of the web server 132.

In at least some example embodiments, a web browser 325 (FIG. 3) operating on an electronic device 301 (FIG. 1) may communicate an HTTP request to the web server 132 over the Internet. The web server 132 may receive the request and, in response to the request, the web server 132 may search the memory 230 for the associated HTML documents (or may generate the HTML documents if the request is a dynamic request). If the associated HTML documents are found, the web server 132 delivers the HTML documents to the electronic device 301 (FIG. 1) over the Internet via the communication system 220. If, however, the associated HTML documents are not found, the web server 132 may deliver an error message to the electronic device 301 (FIG. 1) indicating that the HTML documents do not exist or are unavailable.

The web server 132 illustrated in FIG. 2 is an example web server. In other example embodiments, web servers may be used which have configurations and/or functions which are not specifically described herein.

### Example Electronic Device

Reference is now made to FIG. 3 which illustrates an example electronic device 301. In the illustrated example embodiment, the electronic device 301 is a communication device, such as a mobile communication device. In at least some example embodiments, the electronic device 301 is a two-way communication device having data and voice communication capabilities, and the capability to communicate with other computer systems, for example, via the Internet.

Depending on the functionality provided by the electronic device 301, in various example embodiments the electronic device 301 may be a multiple-mode communication device configured for both data and voice communication, a mobile telephone such as a smartphone, a tablet computer such as a slate computer, a wearable computer such as a watch, a PDA (personal digital assistant) or a computer system.

A smartphone is a mobile phone which offers more advanced computing capability than a basic non-smartphone cellular phone. For example, a smartphone may have the ability to run third party applications which are stored on the smartphone.

A tablet computer (which may also be referred to as a tablet) is an electronic device 301 which is generally larger than a mobile phone (such as a smartphone) or personal digital assistant. Many mobile phones or personal digital assistants are designed to be pocket sized. That is, mobile phones or personal digital assistants are generally small enough to be carried by a person easily, often in a shirt or pant pocket while tablet computers are larger and may not fit within pant pockets. For example, many tablet computers have a height which is seven inches (7″) or more. In some example embodiments, the tablet computer may be a slate computer. A slate computer is a tablet computer which does not include a dedicated keyboard. A slate computer may allow for text input through the use of a virtual keyboard or an external keyboard which connects to the slate computer via a wired or wireless connection.

In other example embodiments, the electronic device 301 may be of a type not specifically listed above.

The electronic device 301 includes a housing (not shown) which houses components of the electronic device 301. Internal components of the electronic device 301 may be constructed on a printed circuit board (PCB). The electronic device 301 includes a controller including at least one processor 340 (such as a microprocessor) which controls the overall operation of the electronic device 301. The processor 340 interacts with device subsystems such as a wireless communication subsystem 311 for exchanging radio frequency signals with a wireless network 101 to perform communication functions. The processor 340 interacts with additional device subsystems including one or more input interfaces 306 (such as a keyboard, one or more control buttons, one or more microphones 358, and/or a touch-sensitive overlay associated with a touchscreen display), flash memory 344, random access memory (RAM) 346, read only memory (ROM) 348, auxiliary input/output (I/O) subsystems 350, a data port 352 (which may be a serial data port, such as a Universal Serial Bus (USB) data port), one or more output interfaces 305 (such as a display 304 (which may be a liquid crystal display (LCD)), one or more speakers 356, or other output interfaces 305), a short-range communication subsystem 362, and other device subsystems generally designated as 364. Some of the subsystems shown in FIG. 1 perform communication-related functions, whereas other subsystems may provide “resident” or on-device functions.

The electronic device 301 may include a touchscreen display in some example embodiments. The touchscreen display may be constructed using a touch-sensitive input surface connected to an electronic controller. The touch-sensitive input surface overlays the display 304 and may be referred to as a touch-sensitive overlay. The touch-sensitive overlay and the electronic controller provide a touch-sensitive input interface 306 and the processor 340 interacts with the touch-sensitive overlay via the electronic controller. That is, the touchscreen display acts as both an input interface 306 and an output interface 305.

The communication subsystem 311 includes a receiver 314, a transmitter 316, and associated components, such as one or more antenna elements 318 and 321, local oscillators (LOs) 313, and a processing module such as a digital signal processor (DSP) 315. The antenna elements 318 and 321 may be embedded or internal to the electronic device 301 and a single antenna may be shared by both receiver 314 and transmitter 316, as is known in the art. The particular design of the wireless communication subsystem 311 depends on the wireless network 101 in which the electronic device 301 is intended to operate.

The electronic device 301 may communicate with any one of a plurality of fixed transceiver base stations of the wireless network 101 within its geographic coverage area. The electronic device 301 may send and receive communication signals over the wireless network 101 after the required network registration or activation procedures have been completed. Signals received by the antenna 318 through the wireless network 101 are input to the receiver 314, which may perform such common receiver functions as signal amplification, frequency down conversion, filtering, channel selection, etc., as well as analog-to-digital (A/D) conversion. A/D conversion of a received signal allows more complex communication functions such as demodulation and decoding to be performed in the DSP 315. In a similar manner, signals to be transmitted are processed, including modulation and encoding, for example, by the DSP 315. These DSP-processed signals are input to the transmitter 316 for digital-to-analog (D/A) conversion, frequency up conversion, filtering, amplification, and transmission to the wireless network 101 via the antenna 318. The DSP 315 not only processes communication signals, but may also provide for receiver and transmitter control. For example, the gains applied to communication signals in the receiver 314 and the transmitter 316 may be adaptively controlled through automatic gain control algorithms implemented in the DSP 315.

In some example embodiments, the auxiliary input/output (I/O) subsystems 350 may include an external communication link or interface, for example, an Ethernet connection. The electronic device 301 may include other wireless communication interfaces for communicating with other types of wireless networks, for example, a wireless network such as an orthogonal frequency division multiplexed (OFDM) network. The auxiliary I/O subsystems 350 may include a pointing or navigational tool (input device) such as a clickable trackball or scroll wheel or thumbwheel, or a vibrator for providing vibratory notifications in response to various events on the electronic device 301 such as receipt of an electronic message or incoming phone call, or for other purposes such as haptic feedback (touch feedback).

In some example embodiments, the electronic device 301 also includes a removable memory module 330 (typically including flash memory) and a memory module interface 332. Network access may be associated with a subscriber or user of the electronic device 301 via the memory module 330, which may be a Subscriber Identity Module (SIM) card for use in a GSM network or other type of memory module for use in the relevant wireless network type. The memory module 330 may be inserted in or connected to the memory module interface 332 of the electronic device 301.

The electronic device 301 may store data 327 in an erasable persistent memory, which in one example embodiment is the flash memory 344. In various example embodiments, the data 327 may include service data having information required by the electronic device 301 to establish and maintain communication with the wireless network 301. The data 327 may also include user application data such as email messages, address book and contact information, calendar and schedule information, notepad documents, image files, and other commonly stored user information stored on the electronic device 301 by its user, and other data. The data 327 stored in the persistent memory (e.g. flash memory 344) of the electronic device 301 may be organized, at least partially, into a number of databases or data stores each containing data items of the same data type or associated with the same application. For example, email messages, contact records, and task items may be stored in individual databases within the electronic device 301 memory.

The data port 352 may be used for synchronization with a user's host computer system 117 (FIG. 1). The data port 352 enables a user to set preferences through an external device or software application and extends the capabilities of the electronic device 301 by providing for information or software downloads to the electronic device 301 other than through the wireless network 101. The alternate download path may for example, be used to load an encryption key onto the electronic device 301 through a direct, reliable and trusted connection to thereby provide secure device communication.

In some example embodiments, the electronic device 301 is provided with a service routing application programming interface (API) which provides an application with the ability to route traffic through a serial data (i.e., USB) or Bluetooth® (Bluetooth® is a registered trademark of Bluetooth SIG, Inc.) connection to the host computer system using standard connectivity protocols. When a user connects their electronic device 301 to the host computer system via a USB cable or Bluetooth® connection, traffic that was destined for the wireless network 101 is automatically routed to the electronic device 301 using the USB cable or Bluetooth® connection. Similarly, any traffic destined for the wireless network 101 is automatically sent over the USB cable Bluetooth® connection to the host computer 117 (FIG. 1) for processing.

The electronic device 301 also includes a battery 338 as a power source, which is typically one or more rechargeable batteries that may be charged, for example, through charging circuitry coupled to a battery interface 336 such as the serial data port 352. The battery 338 provides electrical power to at least some of the electrical circuitry in the electronic device 301, and the battery interface 336 provides a mechanical and electrical connection for the battery 338. The battery interface 336 is coupled to a regulator (not shown) which provides power V+ to the circuitry of the electronic device 301.

The short-range communication subsystem 362 is an additional optional component which provides for communication between the electronic device 301 and different systems or devices, which need not necessarily be similar devices. For example, the short-range communication subsystem 362 may include an infrared device and associated circuits and components, or a wireless bus protocol compliant communication mechanism such as a Bluetooth® communication module to provide for communication with similarly-enabled systems and devices.

A predetermined set of applications that control basic device operations, including data and possibly voice communication applications may be installed on the electronic device 301 during or after manufacture. Additional applications and/or upgrades to an operating system 322 or software applications 324 may also be loaded onto the electronic device 301 through the wireless network 101, the auxiliary I/O subsystem 350, the data port 352, the short-range communication subsystem 362, or other suitable device subsystems 364. The downloaded programs or code modules may be permanently installed, for example, written into the program memory (e.g. the flash memory 344), or written into and executed from the RAM 346 for execution by the processor 340 at runtime.

In some example embodiments, the electronic device 301 may provide two principal modes of communication: a data communication mode and a voice communication mode. In the data communication mode, a received data signal such as a text message, an email message, or webpage download will be processed by the communication subsystem 311 and input to the processor 340 for further processing. For example, a downloaded webpage may be further processed by a web browser 325 or an email message may be processed by the email messaging application and output to the display 304. A user of the electronic device 301 may also compose data items, such as email messages; for example, using an input interface 306 in conjunction with the display 304. These composed items may be transmitted through the communication subsystem 311 over the wireless network 101.

In the voice communication mode, the electronic device 301 provides telephony functions and may operate as a typical cellular phone. The overall operation is similar to the data communication mode, except that the received signals would be output to the speaker 356 and signals for transmission would be generated by a transducer such as the microphone 358. The telephony functions are provided by a combination of software/firmware (i.e., a voice communication module) and hardware (i.e., the microphone 358, the speaker 356 and input devices). Alternative voice or audio I/O subsystems, such as a voice message recording subsystem, may also be implemented on the electronic device 301. Although voice or audio signal output may be accomplished primarily through the speaker 356, the display 304 may also be used to provide an indication of the identity of a calling party, duration of a voice call, or other voice call related information.

The processor 340 operates under stored program control and executes software modules 320 stored in memory such as persistent memory; for example, in the flash memory 344. As illustrated in FIG. 3, the software modules 320 may include operating system software 322 and one or more additional applications 324, such as a web browser 325. In the example embodiment of FIG. 3, the web browser 325 is implemented as a separate stand-alone application 324, but in other example embodiments, the web browser 325 could be implemented as part of the operating system 322 or another application 324.

The electronic device 301 may include a range of additional software applications 324, including, for example, a notepad application, voice communication (i.e. telephony) application, mapping application, or a media player application, or any combination thereof. Each of the software applications 324 may include layout information defining the placement of particular fields and graphic elements (e.g. text fields, input fields, icons, etc.) in the user interface (i.e. the display 304) according to the application.

The software modules 320 or parts thereof may be temporarily loaded into volatile memory such as the RAM 346. The RAM 346 is used for storing runtime data variables and other types of data or information. Although specific functions are described for various types of memory, this is merely one example, and a different assignment of functions to types of memory could also be used.

The web browser 325 is capable of retrieving and displaying a webpage in response to navigation instructions received from a user of an electronic device 301. The web browser 325 may use a URL to establish a hypertext transfer protocol (HTTP) or hypertext transfer protocol secure (HTTPS) connection to a webpage at an address corresponding to the URL over the Internet. That is, the web browser 325 may obtain webpages from one or more web servers 132, such as the web server 132 of FIG. 2.

The web browser 325 may be equipped with a scripting engine to run client-side scripts such as a JavaScript engine for accessing HTML (Hypertext Markup Language) webpages that include JavaScript code. As will be appreciated, JavaScript is a scripting language used in client-side web document, for example, in webpages. The JavaScript engine of the web browser 325 (also known as JavaScript interpreter or JavaScript implementation) is an interpreter that interprets JavaScript scripts embedded in or included from HTML documents and executes the scripts accordingly. Other scripting languages may be used such as, for example, Visual Basic for Applications (VBA), VBScript, and Visual Basic .NET all from Microsoft Corporation.

The web browser 325 also includes multiple and various graphical user interfaces (GUIs) to provide a user with an interface to interact with the web browser 325. A GUI is a type of user interface that allows the user to interact with a device and/or an application utilizing images rather than text commands. The GUI represents information and actions available to the user through graphical icons and visual indicators. The GUI can be implemented by various programming languages including JavaScript, .NET, C++, etc.

The web browser 325 may be Internet Explorer' by Microsoft Corporation, FireFox™ by Mozilla Corporation, or any other web browser having the necessary capabilities for implementing the functions described herein. In some example embodiments, the web browser 325 is provided by the designer or manufacturer of the electronic device 301. The web browser 325 may also be referred to as an Internet browser in at least some example embodiments.

In at least some example embodiments, the web browser 325 is configured to receive navigational instructions from a user of the electronic device 301 to navigate to and retrieve a webpage. In response to receiving the navigational instructions, the web browser 325 retrieves the webpage from a web server 132 (FIG. 2) and displays the webpage on an output interface 305 (i.e. the display 304) of the electronic device 301.

The webpage may include one or more other party's identifier 242 (FIG. 2) (such as URLs or other links) that are user selectable within the web browser 325. As described above with reference to FIG. 2, the other party's identifier 242 (FIG. 2) may be associated with the other party's profile 240. In at least some example embodiments, the other party's identifier 242 identifies the location of one or more of the other party's profiles 242. In response to receiving a selection of an other party's identifier 242, the other party's profile 240 associated with the other party's identifier is received by the web browser 325 from the web server 132. The web browser 325 is, in at least some example embodiments, configured to store the other party's profile 240 in memory (for example, the flash memory 344) of the electronic device 301. In at least some example embodiments, the web browser 325 may be configured to modify itself based on the other party's profile 240.

More particularly, in at least some example embodiments, the other party's profile 240 may configure the web browser 325 to initiate a browsing experience of the other party. While the web browser 325 provides the browsing experience of the other party, it may allow a user of the electronic device 201 to utilize the other party's profile 240 to experience the web as though they were the other party (if the other party is a person) or as though they were a member of the other party (if the other party is an organization). That is, the web browser may temporarily use a location, options, preferences, historical information, characteristics, bookmarks and/or other parameters associated with the other party to allow the user of the electronic device 201 to experience the web as though they were another person or a member of the other party. For example, the web browser may enter an other party browsing mode (e.g. either automatically or upon user instruction) in which the other party's profile 240 may be used to influence behaviour on the electronic device 201. For example, in some example embodiments, a user may be presented with bookmarks associated with the other party's profile.

In some example embodiments, a user may inherit location information associated with the other party's profile so that, when the web browser 325 shares a location with a web server 132, it may share the location defined by the other party's profile instead of (or in addition to) a location defined by a user of the electronic device 301. Web servers 132 may be configured to use such location information in order to provide webpages and/or search results which are tailored to a received location. Accordingly, web servers 132 may, therefore, provide the electronic device 301 with webpages and/or search results which are tailored to the location associated with the other party's profile 240.

Similarly, in some example embodiments, a user's web browsing experience may be modified using one or more cookies associated with the other party's profile 240. A cookie may also be referred to as a web cookie or a browser cookie. A cookie stores information which may be used by one or more web servers 132 to provide information to that web server 132. For example, in at least some example embodiments, a cookie may be used by a web server 132 for authentication, identification, to set preferences, to define shopping cart contents, etc. Accordingly, in at least some example embodiments in which the other party's profile 325 includes one or more cookies associated with the other party, the web browser 325 may store the cookies in memory associated with the electronic device 301. Later, when the user of the electronic device 301 navigates to a webpage associated with the cookies, the electronic device 301 may provide an associated cookie to the website and the website may use the cookie in order to provide webpages to the electronic device 301 which are customized based on the other party; for example, webpages may be provided which are tailored to the other party.

For example, when a user visits an e-commerce website (such as Amazon™), the cookies may inform the e-commerce website of one or more products which were viewed, purchased by, recommended and/or liked by the other party. The e-commerce website may be configured to use this information to provide webpages based on such products. For example, the e-commerce website may provide webpages which list products which were viewed, purchased by, recommended and/or liked by the other party. In some example embodiments, the e-commerce website may use information about products the other party purchased, liked, recommended and/or viewed to provide webpages which list products which would likely be of interest to the other party. That is, in response to receiving the other party's cookie from an electronic device 301 associated with a user (who is not the other party) the e-commerce website may provide to the electronic device 301 information regarding products which may be of interest to the other party.

In at least some example embodiments, the other party's profile 240 may include one or more cookies and also one or more bookmarks. In at least some example embodiments, one or more of the cookies which are provided in the other party's profile 240 are cookies which are associated with bookmarked websites defined in the bookmarks of the other party's profile 240. That is, the bookmarks may effectively tell a user where to go to browse the web as if the user were the other party (if the other party is a person) or as if the user is a member of the other party (if the other party is an organization). and the cookies provide a web browsing experience which is tailored to the other party to allow the user to more fully experience the web as though they were the other party or a member of the other party. In at least some example embodiments, all of the cookies provided in the other party's profile are associated with a website defined by a bookmark provided in the other party's profile.

In at least some example embodiments, while the web browser is in an other party browsing mode in which it is providing the other party browsing experience, one or more features associated with a user profile for a user of the electronic device 301 are temporarily stopped or suspended. For example, use of one or more cookies, one or more bookmarks, a browsing history and/or a location associated with the user may temporarily be suspended to allow one or more cookies, one or more bookmarks, a browsing history and/or a location associated with the other party's profile to be used instead. For example, in at least some example embodiments, the web browser may be configured to suspend use of one or more user cookies which are defined for webpages to allow an other's party cookie defined in the other party's profile 240 to be used instead.

Accordingly, after the web browser 325 receives the other party's profile information from a web server 132, in at least some example embodiments, the web browser 325 may send information associated with the other party's profile to a server (which may be a different server than the web server 132 from where the other party's profile was received). For example, as noted above, in at least some example embodiments, other party's profile 240 information (such as a cookie) may be provided to an e-commerce website to provide an e-commerce experience which is customized for the other party. Similarly, in some example embodiments, the other party's profile 240 information may be provided from the web server 325 to a search engine server 136 to provide search engine results which are customized for the other party.

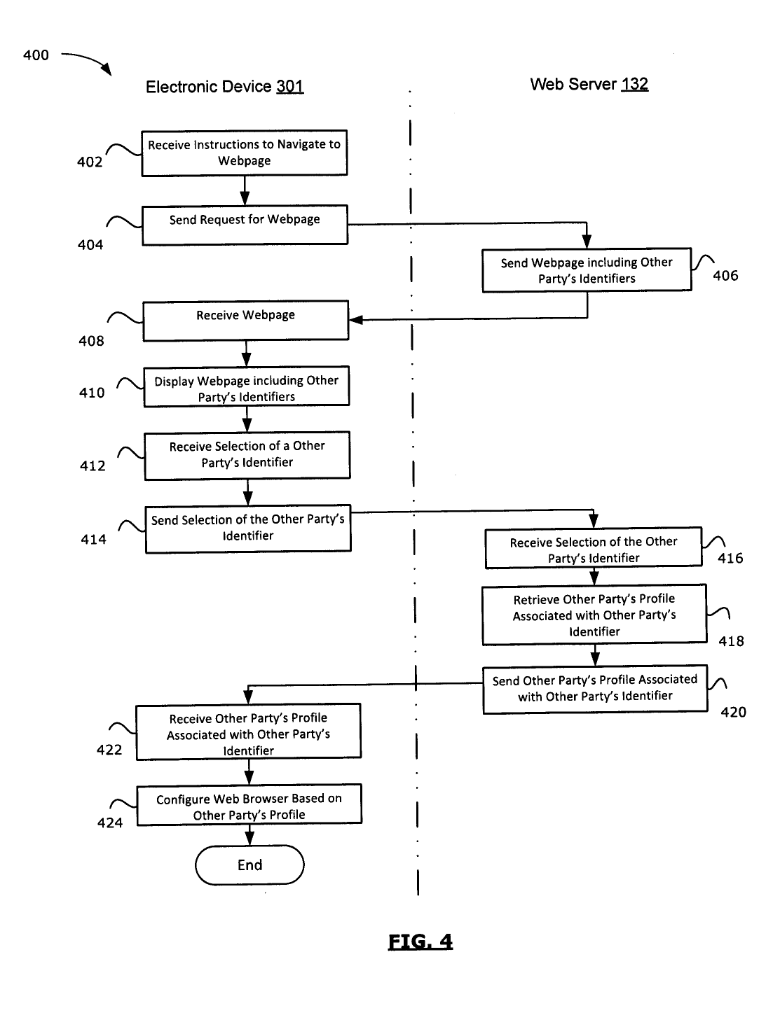

Specific functions and features of the electronic device 301, the web browser 325, the web server 132 and the search engine server 136 will be discussed in greater detail below with reference to FIGS. 4 to 7.

In at least some example embodiments, the operating system 322 may perform some or all of the functions of the web browser 325. In other example embodiments, the functions or a portion of the functions of the web browser 325 may be performed by one or more other applications. Further, while the web browser 325 has been illustrated as a single block, the web browser 325 may include a plurality of software modules. In at least some example embodiments, these software modules may be divided among multiple applications.

### Receiving an Other Party's Profile to Influence a Web Browser

Reference will now be made to FIGS. 4 to 7 in which example methods 400, 500, 600, 700 of using an other party's profile to influence a web browser 325 are illustrated in flowchart form. The methods 400, 500, 600, 700 include features which may be provided by an electronic device 301. Some of the methods also include features which may be provided by a web server 132 (such features are generally illustrated on the right portion of the flowcharts). One or more application or module (such as the web browser 325) on the electronic device 301 may contain computer readable instructions for causing a processor 340 associated with the electronic device 301 to perform the electronic device-specific features and one or more application or module on the web server 132 may contain computer readable instructions for causing a processor 210 associated with the web server 132 to perform the web server-specific features.

Any one or more features of the methods 400, 500, 600, 700 of FIGS. 4 to 7 may, in at least some example embodiments, be provided by other systems, software applications or modules apart from those specifically discussed herein.

Referring to FIG. 4, a flowchart of an example method 400 of using an other party's profile to configure a web browser 325 of an electronic device 301 is illustrated. At 402, the web browser 325 receives instructions to navigate to a webpage which includes an other party's identifier. In at least some example embodiments, the web browser 325 may display an address bar which allows a user of the electronic device 301 to input a URL associated with the webpage. The address bar is a user interface element within the web browser 325 that is capable of receiving data including URLs. In at least some such example embodiments, the instructions to navigate to the webpage may be received via the address bar. For example, such instructions may be received via text entry in the address bar or through a selection of a suggested or previously viewed page from a dropdown box associated with the address bar.

In other example embodiments, instructions to navigate to the webpage may be received via selection of a link to the webpage. The link may be included in another webpage as a selectable user interface element. In some example embodiments instructions to navigate to a webpage may be received via a selection of one or more bookmarks from a bookmark area of the web browser 325. Other methods of inputting and receiving an instruction to navigate to a webpage apart from the methods described herein may also be used.

Accordingly, instructions to navigate to a webpage which includes an other party's identifier may be received at the electronic device 301 from an input interface 306 associated with the electronic device 301. That is, the instructions to navigate to the webpage may be input to the web browser 325 of the electronic device 301 using a navigational input device such as a mouse, trackball, track pad or touchscreen, or a physical keyboard associated with the electronic device 301.

In response to receiving instructions to navigate to a webpage which includes the other party's identifier, the web browser 325, at 404, sends a request for the webpage to a web server 132 hosting the webpage. The web browser 325 may use the URL of the webpage to establish an HTTP or HTTPS connection over a network 124 (for example, the Internet) to the webpage at an address corresponding to the URL. The address identifies the address of the web server 132 hosting the webpage.

After having received the request for the webpage including the other party's identifier, the web server 132 may, at 406, send the requested webpage to the electronic device 301 which requested the webpage at 404. In at least some example embodiments, at 406, the web server 132 may retrieve the requested webpage from memory 230 or, if the web server 132 is configured to provide dynamic webpages, may generate the requested webpage.

The webpage includes an other party's identifier 242 which is both configured for display (e.g. on the electronic device 301) and for selection. That is, the other party's identifier 242 included in the webpage is both displayable and selectable. In at least some example embodiments, the webpage includes the other party's identifier 242 as a selectable link, which may be referred to as an other party's identifier link. The other party's identifier 242 is described in greater detail above with reference to FIGS. 2 and 3.

Next at 408, the electronic device 301, receives the sent webpage including the other party's identifier from the web server 132. The webpage may be received in the form of an HTML document. In response to receiving the webpage, the web browser 325, at 410, displays the webpage using an output interface 305 (for example, the display 304) of the electronic device 301. The displayed webpage includes the other party's identifier 242. That is, the other party's identifier 242 is displayed.

The other party's identifier 242 may, at 410, be displayed as a selectable link, which may be associated with an other party's profile 240. The other party's identifier link may be displayed within the webpage as an interface element. The other party's profile 240 is a profile defined for an other party who is not the user of the electronic device 301. The other party's profile 240 is described in greater detail above with reference to FIGS. 2 and 3.

In at least some example embodiments, the other party's identifier 242 may specify one or more names associated with the other party defining the other party's profile. For example, for an other party who is a celebrity (e.g. “Oprah Winfrey”), the other party's identifier 242 may specify the name of the celebrity (e.g. by displaying “Oprah Winfrey”). The name may be a selectable link associated with an other party's profile 240 associated with that other party.

Next, at 412, the web browser 325 may receive a selection of the other party's identifier 242 (for example, a selection of the other party's identifier link). The selection of the other party's identifier 242 within the web browser 325 may be received from an input interface 306 associated with the electronic device 301. For example, the selection may be received from a user who is using a navigational input device such as a mouse, trackball, track pad or touchscreen, or a physical keyboard associated with the electronic device 301.

In response to receiving the selection of the other party's identifier 242, the web browser 325, at 414, sends the selection of the other party's identifier to the web server 132 hosting the other party's profile associated with the other party's identifier. More particularly, selection of the other party's identifier, may cause the web browser 325 to retrieve the other party's profile 240 specified by the other party's identifier 242 from the web server 132.

The sent selection of the other party's identifier 242 from the web browser 325 is received, at 416, by the web server 132. That is, the web server 132 receives a selection of the other party's identifier 242 at 416.

After having received the selection of the other party's identifier 242 the web server 132, at 418, retrieves the other party's profile 240 associated with the selected other party's identifier 242. In at least some example embodiments, the other party's profile 240 may be stored in the memory 230 of the web server 132. In such example embodiments, the web server 132 may retrieve the other party's profile 240 from the memory 230. In other example embodiments, the web server 132 may retrieve the other party's profile from another server, device and/or system. The server, device and/or system storing the other party's profile may be remotely connected to the web server 132.

The other party's profile 240 includes information associated with the other party and may, for example, include: a cookie, a bookmark, a web browsing history, and/or a geographic location associated with the other party.

A cookie stores information which may be used by one or more web servers 132 to provide information to that web server. For example, in at least some example embodiments, a cookie may be used by a web server for authentication, identification, to set preferences, to define shopping cart contents, etc. In this case, the cookie is related to the other party. That is, the cookie contains the other party's specific information such as, for example, identification information for the other party, information about products that the other party purchased, liked, recommended and/or viewed, or other information specific to that other party. The cookie may define a preference of an other party associated with the other party's profile 240.

A bookmark is a link to one more webpages within the web browser. The bookmarks which are included in the other party's profile are bookmarks which are associated with the other party. For example, the bookmarks included in the other party's profile may include one or more bookmarks selected by the other party.

A web browsing history is a list of webpages which have been previously requested. Accordingly, in at least some example embodiments, the other party's profile 240 may include information about websites which were previously viewed by the other party.

In at least some example embodiments, the other party's profile 240 may include a geographic location associated with the other party. A geographic location is an address or other geographic locator. The address may be a personal or a work address of the other party.

The other party's profile 240 may include information which was generated during a web browsing session of the other party. That is, the other party's profile 240 may include information which was generated when the other party was using a web browser to navigate the Internet.

Next at 420, the web server 132 sends the retrieved other party's profile 240 to the electronic device 301. The sent other party's profile is received by the electronic device 301 at 422. That is, the electronic device 301 receives the other party's profile 240 which is associated with the other party's identifier 242 selected at 412 of FIG. 4.

The web browser 325, then at 424, configures the web browser based on the other party's profile (at 424).

Accordingly, in response to receiving the selection of the other party's identifier 242 at 412, the electronic device 301 receives the other party's profile 240 associated with that other party's identifier 242 and then configures the web browser 325 based on that other party's profile 240.

In at least some example embodiments, the received other party's profile 240 may be used by the electronic device 301 to influence the web browser 325. That is, at 424, a browsing experience of the other party may be initiated in which the other party's profile 240 influences the web browser 325 and/or the web browsing experience.

In at least some example embodiments, at 424, the electronic device 201 may configure the web browser by storing the other party's profile 240 (or a portion thereof) in memory of the electronic device 301. The other party's profile 240 (or a portion thereof) may be stored in an area of memory which contains similar data for a user of the electronic device 301.

For example, a bookmark included in the other party's profile 240 may be automatically stored in a bookmarks area in the memory of the electronic device 301 which may include one or more user-defined bookmarks. Accordingly, where the other party's profile includes a bookmark, the electronic device 201 may configure the web browser 325 to include the bookmark in a bookmarks area of the web browser.

Similarly, a cookie included in the other party's profile 240 may be automatically stored in a cookie area in the memory of the electronic device 301, a web browsing history included in the other party's profile 240 may be stored in a web browsing history area of the memory of the electronic device 301, and a geographic location included in the other party's profile 240 may be stored in a geographic location area of the memory of the electronic device 301.

The bookmarks area, cookie area, web browsing history area, and/or geographic location area may each be folders or other structures which may be used to separate data from other data. Such areas may be specific to the other party (i.e. areas which are used for storing the other party's profile data but which are not used for storing user profile data for a user of the electronic device 301) or may be areas which also store user profile data.

Configuring Based on an Other Party's Profile which Includes Bookmarks

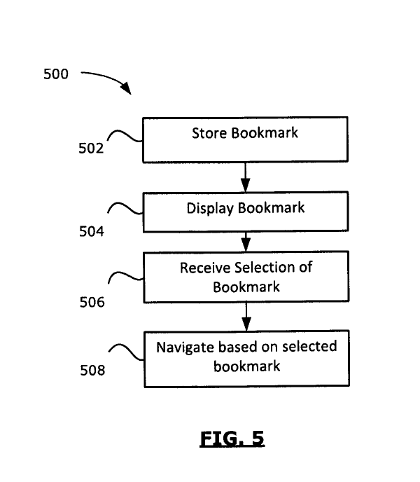

As noted above, in at least some example embodiments, an other party's profile 240 includes one or more bookmarks. An example method 500 of configuring a web browser 325 based on one or more bookmarks is illustrated in FIG. 5. The method 500 may, for example, be performed by the electronic device 301 at 424 of FIG. 4. More particularly, one or more applications or modules on the electronic device 301, such as the web browser 325, may include computer executable instructions for causing a processor to perform the method 500 of FIG. 5.

Referring now to FIG. 5, at 502, the electronic device 301 stores the bookmark included in the other party's profile 240. The electronic device 301 may, in at least some example embodiments, store the bookmark in a bookmarks area of memory of the electronic device 301. The bookmarks area of memory may contain only bookmarks included in the other party's profile 240, or may also include other bookmarks such as bookmarks defined by a user of the electronic device 301.

Next, at 504, the electronic device may display the bookmark in a bookmarks area of a web browser 325. That is, the web browser 325 may include a graphical user interface which displays the bookmark in a bookmarks area as a selectable interface element. The bookmarks area of the web browser may also be referred to as a favorites area.

Next, at 506, the electronic device 506 may receive a selection of the bookmark which was included in the other party's profile 240 and may, in response, navigate to a webpage based on the selected bookmark (at 508). That is, the web browser 325 may retrieve the webpage at an address specified by the bookmark.

Configuring Based on an Other Party's Profile which Includes Cookies

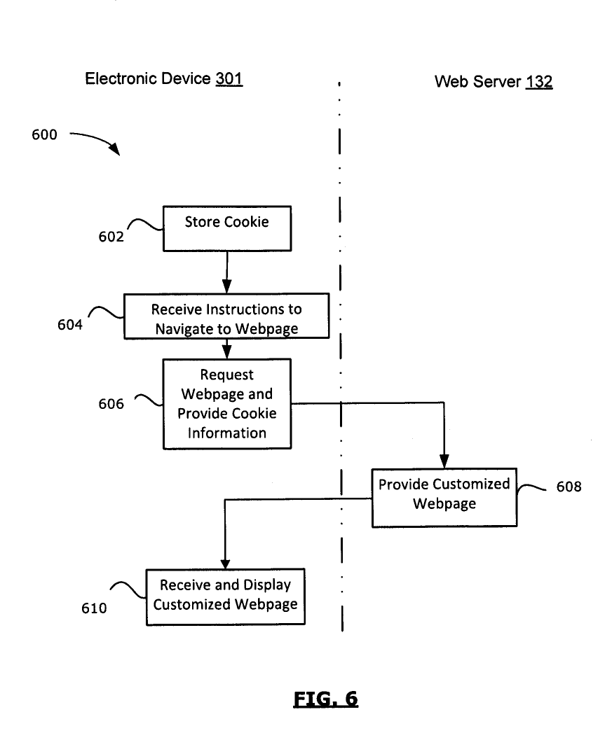

As noted above, in at least some example embodiments, the other party's profile 240 includes one or more cookies (or other information about a user's preferences, likes, characteristics, etc.). An example method 600 of configuring a web browser 325 of an electronic device 301 based on one or more cookies is illustrated in FIG. 6. The electronic device 301 may be configured to perform at least a portion of the method 600. More particularly, an application or module provided on the electronic device 301, such as the web browser 325 may include computer executable instructions which, when executed, cause a processor associated with the electronic device 301 to perform the electronic device-specific features of the method 600. A web server 132 (which may be the web server of FIG. 2 or another type of web server) may be configured to perform the server specific steps of the method 600. That is, a web server 132 may include one or more applications or modules containing computer executable instructions which, when executed, cause the web server 132 to perform the server-specific features of FIG. 6. The method 600 may be performed at 424 of FIG. 4.

Referring now to FIG. 6, at 602, the electronic device 201 stores one or more cookies included in a received other party's profile 240. The electronic device 201 may automatically store a cookie from the other party's profile 240 in a cookie area in the memory of the electronic device 301. The cookie area may, for example, be an area which stores cookies received during a browsing session initiated by a user of the electronic device 201. That is, the cookie area may store user cookies and may also store other party cookies.

A cookie may relate to one or more specific webpages. At 604, the web browser 325 receives instructions to navigate to one of those webpages. The instructions may be received in the manner described above with reference to 402 of FIG. 4.

Next, at 606, the web browser 325 requests the webpage from the web server 132 (this may be a different web server than the web server from which the other party's profile 240 was received in FIG. 4) and sends information associated with the other party's profile from the electronic device to the web server 132. More specifically, in at least some example embodiments, the electronic device 301 provides cookie information to the web server 132. In at least some example embodiments, at 606, the electronic device 301 sends the cookie to the web server 132.

In response, the web server 132 (which may be a different web server than the web server from which the other party's profile 240 was received in FIG. 4) may provide (at 608) a customized webpage to the electronic device 201. The webpage is customized by the web server 132 based on the other party's profile 240. For example, the webpage may be customized based on the cookie.

In at least some example embodiments, the web server 132 of FIG. 6 may provide an e-commerce website. In at least some such example embodiments, when a user visits the e-commerce website (i.e. by instructing the web browser to navigate to that website at 604), the cookie may inform the e-commerce website of: the identity of the other party, and/or one or more products which were viewed and/or purchased by the other party and/or products which are recommended or liked by the other party. The e-commerce website may be configured to use this information to provide webpages which are based on such products. For example, the e-commerce website may provide webpages which list products which were viewed and/or purchased by the other party and/or products which are recommended or liked by the other party. In some example embodiments, the e-commerce website may use information about products the other party purchased, liked, recommended and/or viewed to provide webpages which list products which would likely be of interest to the other party. Accordingly, in response to receiving the other party's cookie from an electronic device 301 associated with a user (who is not the other party), the e-commerce website may provide (at 608) to the electronic device 301 information regarding products which may be of interest to the other party.

In some example embodiments, the web server 132 of FIG. 6 may be a search engine server 136 (FIG. 1). In at least some such example embodiments, the search engine server 136 may use the cookie (or other profile information of the other party) to provide search results to a web browser which are based on the other party's profile.

The webpage provided by the web server 132 may be received at the electronic device 301 at 610 and displayed on the display 304 of the electronic device 301.

Configuring Based on an Other Party's Profile which Includes Web Browsing History

As noted above, in at least some example embodiments, the other party's profile 240 includes a web browsing history associated with the other party. The web browsing history may be a record of websites visited by the other party.

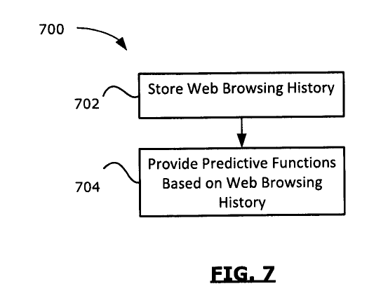

An example method 700 of configuring a web browser 325 based on a web browsing history included in an other party's profile 240 is illustrated in FIG. 7. The method 700 may, for example, be performed by the electronic device 301 at 424 of FIG. 4. More particularly, one or more applications or modules on the electronic device 301, such as the web browser 325, may include computer executable instructions for causing a processor to perform the method 700 of FIG. 7.

Referring now to FIG. 7, at 702, the electronic device 301 stores the web browsing history included in the other party's profile 240. The electronic device 301 may, in at least some example embodiments, store the web browsing history in a web browser history area of memory of the electronic device 301. The web browser history area of memory may contain only a web browsing history included in the other party's profile 240, or may also include a web browsing history for a user of the electronic device 301.

After the web browsing history included in the other party's profile 240 is stored on the electronic device 301, at 704, the web browser 325 may provide predictive functions based on that web browsing history. The predictive functions may include, for example, suggesting one or more websites based on the web browsing history. For example, in at least some example embodiments, the web browser 325 may be configured to suggest a URL of a webpage based on partial input of the webpage URL received from a user. For example, a user may begin typing an address associated with a webpage and then the web browser 325 may make recommendations based on the web browsing history. In at least some example embodiments, the web browser may suggest one or more websites to a user based on a web browsing history for the other party. That is, after a user begins typing an address or search term the web browser 325 may suggest one or more websites based on websites which were previously visited by the other party.

In at least some example embodiments, the web browser 325 may provide multiple browsing modes including a user browsing mode in which the web browser 325 relies on a user profile and an other party browsing mode in which the web browser 325 relies on an other party's profile 240 received from a web server 132. The web browser 325 may be configured to switch between the user browsing mode and the other party browsing mode based on user instructions. For example, a user may instruct the web browser 325 to use either the user's profile or the other party's profile using an input interface associated with the electronic device 301.

In at least some example embodiments, when operating in the other party browsing mode, the web browser 325 may temporarily suspend use of the user profile and may instead use the other party's profile 240.

The other party browsing mode may be terminated in response to receiving input from a user (i.e. via an input interface associated with the electronic device 301) which corresponds to one or more predetermined trigger conditions. In response to receiving such an input, the web browser 325 may stop use of the other party's profile 240 within the web browser and may resume use of a user profile.

In at least some example embodiments, the one or more predetermined trigger conditions may include a direct input from the user. For example, a user may specifically instruct the web browser to stop using the other party's profile 242 (e.g. by selecting an “End Other Party Browsing” interface element or another similar interface element). In some example embodiments, the web browser 325 may be configured to end the other party browsing mode in response to input which is less direct. For example, in at least some example embodiments, resetting the web browser 325 may end the other party browsing mode. That is, when a web browser operating in the other party browsing mode is closed and then re-opened, it may automatically resume browsing in the user browsing mode instead of the other party browsing mode.

While the present application is primarily described in terms of methods, a person of ordinary skill in the art will understand that the present application is also directed to various apparatus such as a handheld electronic device and a server. The handheld electronic device and the server includes components for performing at least some of the example aspects and features of the described methods, be it by way of hardware components (such as the memory and/or the processor), software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, articles of manufacture, and computer data signals also come within the scope of the present application.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

Example embodiments of the present application are not limited to any particular operating system, system architecture, mobile device architecture, server architecture, or computer programming language.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A method implemented by a processor of an electronic device, the method comprising:
receiving a selection of an other party's identifier within a web browser; and
in response to receiving the selection of the other party's identifier:
receiving an other party's profile associated with the other party's identifier; and
configuring the web browser based on the other party's profile.

2. The method of claim 1, wherein configuring the web browser based on the other party's profile comprises:
initiating an other party's browsing experience in which the other party's profile influences the web browser.

3. The method of claim 1, wherein configuring the web browser based on the other party's profile comprises:
storing the other party's profile to memory of the electronic device.

4. The method of claim 1, wherein configuring the web browser based on the other party's profile comprises:
temporarily suspending use of a user profile associated with a user of the electronic device.

5. The method of claim 1, wherein configuring the web browser based on the other party's profile comprises:
sending information associated with the other party's profile from the electronic device to a server.

6. The method of claim 5, wherein the server is a search engine and wherein the method further comprises:
receiving search results at the web browser based on the other party's profile.

7. The method of claim 1, wherein the other party's profile is a profile defined for an other party who is not a user of the electronic device.

8. The method of claim 1, wherein the other party's profile includes a cookie.

9. The method of claim 8, wherein the cookie defines a preference of an other party associated with the other party's profile.

10. The method of claim 1, wherein the other party's profile includes a bookmark and wherein configuring the web browser based on the other party's profile comprises:
configuring the web browser to include the bookmark in a bookmarks area of the web browser.

11. The method of claim 1, wherein the other party's profile includes a web browsing history and wherein configuring the web browser based on the other party's profile comprises configuring the web browser based on the web browsing history.

12. The method of claim 1, wherein the other party's profile includes a geographic location associated with the other party and wherein configuring the web browser based on the other party's profile comprises configuring the web browser based on the geographic location.

13. The method of claim 1, further comprising:
displaying a webpage including the other party's identifier,
and wherein receiving a selection of an other party's identifier comprises receiving a selection of the other party's identifier displayed in the webpage.

14. The method of claim 1, further comprising:
receiving input corresponding to a predetermined trigger condition; and
in response to receiving the input corresponding to the predetermined trigger condition, stopping use of the other party's profile within the web browser.

15. The method of claim 14, wherein the trigger condition is a reset of the web browser.

16. An electronic device comprising:
a processor; and
a memory coupled with the processor, the memory storing a web browser and computer readable instructions for:
receiving a selection of an other party's identifier within a web browser; and
in response to receiving the selection of the other party's identifier:
receiving an other party's profile associated with the other party's identifier; and
configuring the web browser based on the other party's profile.

17. The electronic device of claim 16, wherein the electronic device is a mobile communications device.

18. A method implemented by a processor of a web server, the web server having stored in memory an other party's profile, the method comprising:
receiving a selection of an other party's identifier; and
in response to receiving the selection of the other party's identifier:
retrieving an other party's profile associated with the other party's identifier; and
sending the other party's profile to an electronic device.

19. (canceled)

20. (canceled)

21. (canceled)

22. (canceled)

23. (canceled)

24. (canceled)

25. The electronic device of claim 16 wherein configuring the web browser based on the other party's profile comprises:
initiating an other party's browsing experience in which the other party's profile influences the web browser.

26. The electronic device of claim 16 wherein configuring the web browser based on the other party's profile comprises:
storing the other party's profile to memory of the electronic device.
